(19) United States
(12) Patent Application Publication
(10) Pub. No.: US 2013/0055895 A1
(43) Pub. Date: Mar. 7, 2013

(54) REMOVAL OF CO2 FROM GASES OF LOW CO2 PARTIAL PRESSURES BY MEANS OF 1,2 DIAMINOPROPANE

(71) Applicants: Johannes Menzel, Waltrop (DE); Olaf Von Morstein, Essen (DE)

(72) Inventors: Johannes Menzel, Waltrop (DE); Olaf Von Morstein, Essen (DE)

(73) Assignee: THYSSENKRUPP UHDE GMBH, DORTMUND (DE)

(21) Appl. No.: 13/261,352

(22) PCT Filed: Dec. 20, 2010
(86) PCT No.: PCT/EP10/07799

§ 371 Date: Nov. 7, 2012

(30) Foreign Application Priority Data
Jan. 5, 2010 (DE) 10 2010 004 073.8

(51) Int. Cl. B01D 53/14; B01D 19/00

(52) U.S. Cl. 95/161; 95/236

(57) ABSTRACT

Use of an absorbent for the removal of acid gases from a fluid stream, the absorbent consisting of an aqueous solution of 1,2 diaminopropane.

The invention relates to the use of an absorbent for the purpose of removing CO₂ from technical gases.

The removal of CO₂ from technical gases is of special importance with regard to the reduction of CO₂ emissions, with CO₂ being considered the main cause of the greenhouse effect.

Industry often uses aqueous solutions of organic bases such as alkanolamines, for example, as absorbents for the removal of acid-gas components.

The absorbent is regenerated by supplying heat, depressurising or stripping by means of suitable auxiliary agents. Once the absorbent has been regenerated, it can be reused as a regenerated solvent in the absorption of acid-gas components.

Flue gases from the combustion of fossil-fuels are obtained at approximately atmospheric pressure. As the CO₂ content in the flue gases is typically around 3 to 13 vol. %, the CO₂ partial pressure ranges correspondingly between only 0.03 and 0.13 bar. To achieve an adequate removal of CO₂ from the flue gases at such low CO₂ partial pressures, a suitable absorbent is to have a very high CO₂ absorption capacity. In particular, highest possible absorption capacity should also be ensured already at low CO₂ partial pressures.

The absorption capacity of the absorbent largely determines the required circulation flow rate of the absorbent and thus the size and cost of the necessary equipment. As the energy required for heating and cooling the absorbent is proportional to the circulation flow rate, the regeneration energy required for regenerating the solvent will decrease to a significant degree if the circulation flow rate of the absorbent can successfully be reduced.

Beside a high absorption capacity, however, a suitable absorbent should also have an as high stability towards oxygen as possible, as there is always a certain content of oxygen particularly in flue gases. As known from literature, many amine compounds which are normally characterised by favourable absorption properties decompose easily in the presence of oxygen, which will result in a high absorbent consumption on the one hand and to correspondingly high costs on the other hand. The decomposition products obtained will generally produce a considerably increased level of corrosion and in addition a significantly reduced capacity of the absorbent.

Volatile decomposition products such as ammonia, for example, would cause a contamination of the CO₂ product and the flue gas leaving the CO₂ scrubber with unpermitted emission components. To avoid such emissions, it will be necessary to add further process steps, which will increase the cost of a CO₂ scrubbing unit even further.

The use of an absorbent for the removal of acid gases from a fluid stream is known, for example, from US 2007/0264180 A1. Here, it is taught that 1,2 diaminopropane (termed 1,2-propane diamine) of a concentration of 0 to 30 wt. % can be added to the absorbent as an additional activating agent. The use of an aqueous 1,2 diaminopropane solution which acts as an absorbent in itself is not suggested at all.

For this reason, there is a significant demand for an absorbent which, on the one hand, has an as high CO₂ absorption capacity as possible at low partial pressures of <1 bar, particularly at <0.2 bar, and which is at the same time as stable towards oxygen as possible and also thermally stable under absorbent regeneration conditions. To meet such demand, i.e. to make such an absorbent available, and to provide such a method for the removal of CO₂ from technical gases, these are the aims of the present invention.

The aim is achieved by the use of an absorbent consisting of 1,2 diamino-propane in aqueous solution.

The absorbent generally contains 10 to 90 wt. %, preferably 30 to 65 wt. % 1,2 diaminopropane with reference to the weight of the absorbent.

In an embodiment of the invention the absorbent to be used contains at least one more amine different from 1,2 diaminopropane. Thus the absorbent according to the invention may, for example, contain 5 to 45 wt. %, preferably 10 to 40 wt. % of one or more different amines.

The at least one more amine different from 1,2 diaminopropane is, for example, selected from:
A) tertiary amines of the general formula:

N(R1)₂₋ₙ(R2)₁₊ₙ
in which R1 represents an alkyl group and R2 a hydroxyalkyl group or
tertiary amines of the general formula:

(R1)₂₋ₙ(R2)ₙN—X—N(R1)₂₋ₘ(R2)ₘ
in which R1 represents an alkyl group, R2 a hydroxyalkyl group, X an alkylene group, which is interrupted by oxygen once or several times, and n and m an integer from 0 to 2, or two remainders R1 and R2 bound to different nitrogen atoms together representing an alkylene group,
B) sterically hindered amines,
C) 5, 6, or 7-membered saturated heterocyclic compounds with at least one NH-group in the ring, which may have one or two more heteroatoms selected from nitrogen and oxygen in the ring,
D) primary or secondary alkanolamines,
E) alkylene diamines of the formula:

H₂N—R2-NH₂
in which R2 represents a C₂ to C₆ alkyl group.

In a preferential embodiment of the invention the tertiary amines which are used in addition to 1,2 diaminopropane are selected from a group comprising tris(2-hydroxyethyl)amine, tris(2-hydroxypropyl)amine, tributanolamine, bis(2-hydroxyethyl)-methylamine, 2-diethylaminoethanol, 2-dimethylaminoethanol, 3-dimethylamino-1-propanol, 3-diethylamino-1-propanol, 2-diisopropylaminoethanol, N,N-bis(2-hydroxypropyl)methylamine (methyldiisopropanolamine, MDIPA), N,N,N′,N′-tetramethylethylene diamine, N,N-diethyl-N′,N′-dimethylethylene diamine, N,N,N′,N′-tetraethylethylene diamine, N,N,N′,N′-tetramethylpropane diamine, N,N,N′,N′-tetraethylpropane diamine, N,N-dimethyl-N′,N′-diethylethylene diamine, 2-(2-dimethylaminoethoxy)-N,N-dimethyl ethane amine; 1,4-diazabicyclo[2.2.2]octane (DABCO); N,N,N′-trimethylaminoethyl ethanol amine, N,N′-dimethyl piperazine and N,N′-bis(hydroxyethyl)piperazine. Further potential tertiary amines are disclosed in WO 2008/145658 A1, U.S. Pat. No. 4,217,236 and US 2009/0199713 A1.

In a further embodiment the sterically hindered amines which are used in addition to 1,2 diaminopropane are selected from a group comprising 2-amino-2-methyl-1-propanol, 2-amino-2-methyl-1-butanol, 3-amino-3-methyl-1-butanol, 3-amino-3-methyl-2-pentanol and 1-amino-2-methylpropane-2-ol. Other sterically hindered amines that can be used are mentioned in WO 2008/145658 A1, U.S. Pat. No. 4,217,236, US 2009/0199713 A1, U.S. Pat. No. 5,700,437, U.S. Pat. No. 6,500,397 B1 and U.S. Pat. No. 6,036,931.

Optionally, the 5, 6, or 7-membered saturated heterocyclic compounds which are used in addition to 1,2 diaminopropane are selected from a group comprising piperazine, 2-methyl piperazine, N-methyl piperazine, N-ethyl piperazine, N-aminoethyl piperazine, homopiperazine, piperidine and morpholine. Other compounds that can be used are described in WO 2008/145658 A1 and US 2009/0199713 A1.

The primary or secondary alkanolamines which are used in addition to 1,2 diaminopropane are advantageously selected from a group comprising 2-amino ethanol, N,N-bis(2-hydroxyethyl)amine, N,N-bis(2-hydroxypropyl)amine, 2-(methylamino)ethanol, 2-(ethylamino)ethanol, 2-(n-butylamino)ethanol, 2-amino-1-butanol, 3-amino-1-propanol and 5-amino-1-pentanol. Other potential compounds are again disclosed in documents WO 2008/145658 A1 and US 2009/0199713 A1.

In a further embodiment of the invention the alkyl diamines which are used in addition to 1,2 diaminopropane are selected from a group comprising hexamethylene diamine, 1,4-diaminobutane, 1,3-diaminopropane, 2,2-dimethyl-1,3-diaminopropane, 3-methylaminopropylamine, 3-(dimethylamino)propylamine, 3-(diethylamino)propylamine, 4-dimethylaminobutylamine and 5-dimethylaminopentylamine, 1,1,N,N-tetramethylethanediamine, 2,2,N,N-tetramethyl-1,3-propane diamine, N,N′-dimethyl-1,3-propane diamine, N,N′bis(2-hydroxyethyl)ethylene diamine. In addition, all components can be used that are identified accordingly in WO 2008/145658 A1 and US 2009/0199713 A1, and here in particular MAPA.

Furthermore the use of the absorbent is characterised by the feature that the fluid stream is brought into contact with one of the before-specified absorbents, the absorbent thus being laden with CO₂. This takes place preferentially at a partial pressure of <200 mbar.

The laden absorbent is advantageously regenerated by heating, depressurising, stripping with stripping vapours produced by internal evaporation of the solvent, stripping with an inert fluid or by a combination of two or all of these measures.

The present invention is described below in more detail by means of two examples.

### EXAMPLE 1

### Testing Stability Towards Oxygen

The stability of 1,2 diaminopropane towards the action of oxygen was determined as follows:

The analyses were carried out in a glass apparatus consisting of round-bottom flasks and reflux condensers. The amines were weighed in. An air flow of approx. 12 NI air/hour, pre-saturated with water vapour, was bubbled into the stirred solution at approx. 110° C. over a period of 4 days. To follow up the course of the reaction, daily samples were analysed by gas-chromatography and acid/base titration (0.1 molar hydrochloric acid) to determine the absolute amine content. At the end the flasks were weigh-checked in order to determine the total amount of the solution.

As a result of the pre-saturation of the air with water vapour there was an increase in weight in the flask over the test period. Once the test result had been corrected by the weight increase resulting from the introduced water, it was surprisingly determined after the completion of the test that the concentration of 1,2 diamino-propane (50 wt. %) in the solution was the same as at the beginning of the test. The measurement hence did not prove any change. Correspondingly no colour changes of the 1,2 diaminopropane were observed over the test period. The colour of the 1,2 diaminopropane was light yellow at the beginning and at the end of the test.

In contrast to this, the stability test of a monoethanolamine solution of also approx. 50 wt. % resulted in a final concentration of 44.89 wt. % after 4 days, all other conditions being the same. This corresponds to a solvent loss of approx. 9.6% of the monoethanolamine used during the test period. Correspondingly the colour changes from slightly beige to dark orange.

### EXAMPLE 2

### Determining CO₂ Absorption Capacity

A static phase equilibrium apparatus was used to measure the synthetic gas solubility (isothermal P-x data) by the synthetic measuring principle. In this assembly the pressure is measured for different gross compositions of a mixture at constant temperature. The thermostated, purified and degassed solvent is pumped into an evacuated and thermostated measuring cell by means of metering pumps which allow demonstrating minor differences in volume. Subsequently the gas is added in small portions. The CO₂ then contained in the absorption solution at a defined pressure is calculated under consideration of the gas space.

The CO₂ absorption for a CO₂ partial pressure of approx. 0.1 bar was determined at a temperature of 40° C.

TABLE 1

| Absorbent | Absorption capacity in % |
|---|---|
| MEA (30 wt. %) | 100 |
| DAP (30 wt. %) | 149 |

The results displayed in table 1 show that with identical amine concentration 1,2 diaminopropane (DAP) absorbs approx. 50% more CO₂ than the standard scrubbing agent monoethanolamine (MEA) which is used according to the state of the art.

In the same way as for 40° C., the equilibrium concentration of CO₂ in aqueous solution was determined for 120°. Under the typical regeneration conditions in the desorption column (120° C. at approx. 0.09 bar CO₂ partial pressure) it is then possible to determine the residual load of CO₂. If the remaining residual CO₂ concentration is considered for determining the so-called cyclic absorption capacity, i.e. the CO₂ absorption actually to be reached by the respective solvent, with the absolute CO₂ absorption capacity being reduced by the remaining residual CO₂ load from the regeneration of the solvent, the cyclic absorption capacity of 1,2 diaminopropane (DAP) amounts to approx. 1.6 the cyclic absorption capacity of monoethanolamine (MEA) with identical weight portions of the respective amine in water.

This proves that the cyclic absorption capacity of 1,2 diaminopropane is even higher than the absolute CO₂ absorption capacity relative to monoethanolamine. This indicates that the regeneration of 1,2 diaminopropane—maybe due to the non-straight chain structure of the hydrocarbon groups—achieves lower residual CO₂ loads than the comparable MEA. This constitutes a further advantage of the amine according to the invention.

Hence the invention provides a solvent for the absorption of CO₂, especially in the range of low CO₂ partial pressures and in the presence of oxygen, which is significantly more stable under these conditions on the one hand and has a higher cyclic absorption capacity on the other hand than a comparable solvent according to the state of the art. This proves the specific suitability of the amine according to the invention for the removal of CO₂ from technical gases of low partial pressures (<200 mbar).

1-13. (canceled)

14. A process for the removal of acid gases from a fluid stream, comprising utilizing an absorbent to remove gases from a fluid stream, with the absorbent comprising an aqueous solution of 1,2 diaminopropane.

15. The process according to claim 14, wherein the absorbent contains 10 to 90 wt. % 1,2 diaminopropane with reference to the weight of the absorbent.

16. The process according to claim 14, with the absorbent containing at least one more amine different from 1,2 diaminopropane.

17. The process according to claim 16, with the absorbent containing 5 to 45 wt. % of the at least one amine different from 1,2 diaminopropane.

18. The process according to claim 16, with the at least one more amine different from 1,2 diaminopropane being selected from:
tertiary amines of the general formula:
N(R1)2−n(R2)1+n
in which R1 represents an alkyl group and R2 a hydroxyalkyl group;
or
tertiary amines of the general formula:
(R1)2−n(R2)nN—X—N(R1)2−m(R2)m
in which R1 represents an alkyl group, R2 a hydroxyalkyl group, X an alkylene group, which is interrupted by oxygen once or several times, and n and m an integer from 0 to 2, or two remainders R1 and R2 bound to different nitrogen atoms together representing an alkylene group;
sterically hindered amines,
5, 6, or 7-membered saturated heterocyclic compounds with at least one NH-group in the ring, which may have one or two more heteroatoms selected from nitrogen and oxygen in the ring,
primary or secondary alkanolamines;
alkylene diamines of the formula:
H2N—R2—NH2
in which R2 represents a C2 to C6 alkyl group.

19. The process according to claim 18, with the tertiary amine being selected from a group consisting of: bis-dimethylaminoethyl ether, tris(2-hydroxyethyl)amine, tris(2-hydroxypropyl)amine, tributanolamine, bis(2-hydroxyethyl)-methylamine, 2-diethylaminoethanol, 2-dimethylaminoethanol, 3-dimethylamino-1-propanol, 3-diethylamino-1-propanol, 2-diisopropylaminoethanol, N,N-bis(2-hydroxypropyl)-methylamine (methyldiisopropanolamine, MDIPA), N,N,N′,N′-tetramethyl-ethylene diamine, N,N-diethyl-N′,N′-dimethylethylene diamine, N,N,N′,N′-tetraethylethylene diamine, N,N,N′,N′-tetramethylpropane diamine, N,N,N′,N′-tetraethylpropane diamine, N,N-dimethyl-N′,N′-diethylethylene diamine, 2-(2-dimethylaminoethoxy)-N,N-dimethyl ethane amine; 1,4-diazabicyclo-[2.2.2]octane (DABCO); N,N,N′-trimethylaminoethyl ethanol amine, N,N′-dimethyl piperazine and N,N′-bis(hydroxyethyl)piperazine.

20. The process according to claim 18, with the sterically hindered amine being selected from the group consisting of: 2-amino-2-methyl-1-propanol, 2-amino-2-methyl-1-butanol, 3-amino-3-methyl-1-butanol, 3-amino-3-methyl-2-pentanol and 1-amino-2-methylpropane-2-ol.

21. The process according to claim 18, with the 5, 6, or 7-membered saturated heterocyclic compounds being selected from a group consisting of: piperazine, 2-methyl piperazine, N-methyl piperazine, N-ethyl piperazine, N-aminoethyl piperazine, homopiperazine, piperidine and morpholine.

22. The process according to claim 18, with the primary or secondary alkanoamines being selected from a group consisting of: 2-amino ethanol, N,N-bis(2-hydroxyethyl)amine, N,N-bis(2-hydroxypropyl)amine, 2-(methylamino)ethanol, 2-(ethylamino)ethanol, 2-(n-butylamino)ethanol, 2-amino-1-butanol, 3-amino-1-propanol and 5-amino-1-pentanol.

23. The process according to claim 18, with the alkyl diamines being selected from a group consisting of: hexamethylene diamine, 1,4-diaminobutane, 1,3-diaminopropane, 2,2-dimethyl-1,3-diaminopropane, 3-methylaminopropylamine, 3-(dimethylamino)propylamine, 3-(diethylamino)propylamine, 4-dimethylaminobutylamine and 5-dimethylaminopentylamine, 1,1,N,N-tetramethylethanediamine, 2,2,N,N-tetramethyl-1,3-propane diamine, N,N′-dimethyl-1,3-propane diamine, N,N′ bis(2-hydroxyethyl)ethylene diamine.

24. The process according to claim 14, wherein carbon dioxide is being removed from the fluid stream, comprising bringing the fluid stream into contact with the absorbent and the absorbent thus becoming laden with CO₂.

25. The process according to claim 24, with the absorbent being laden with CO₂ at a partial pressure <200 mbar.

26. The process according to claim 24, comprising regenerating the laden absorbent being by heating, depressurizing, stripping with stripping vapors produced by internal evaporation of the solvent, stripping with an inert fluid, or by a combination of at least two of these measures.

27. The process according to claim 15, with the absorbent containing 30 to 65 wt. % 1,2 diaminopropane with reference to the weight of the absorbent.

28. The process according to claim 16, with the absorbent containing 10 to 40 wt. % of the at least one amine different from 1,2 diaminopropane.

29. Process for the removal of acid gases from a fluid stream, comprising utilizing an absorbent to remove gases from a fluid stream, with the absorbent consisting of an aqueous solution of 1,2 diaminopropane.
